(19) United States
(12) Patent Application Publication
(10) Pub. No.: US 2026/0287959 A1
(43) Pub. Date: Sep. 24, 2026

(54) ELECTRONIC PAPER DISPLAY PANEL, CONTROL METHOD THEREOF, AND DISPLAY DEVICE

(71) Applicant: HKC CORPORATION LIMITED, Shenzhen (CN)

(72) Inventors: XIANFEI ZHU, Shenzhen (CN); Haijiang Yuan, Shenzhen (CN)

(21) Appl. No.: 19/553,227

(22) Filed: Feb. 28, 2026

(30) Foreign Application Priority Data
Mar. 21, 2025 (CN) 202510340202.9

(51) Int. Cl. G02F 1/167; G02F 1/1335; G02F 1/1676; G02F 1/1677; G02F 1/1685

(52) U.S. Cl. CPC G02F 1/167; G02F 1/133514; G02F 1/1676; G02F 1/1677; G02F 1/1685; G02F 2201/121; G02F 2203/02

(57) ABSTRACT

Disclosed are an electronic paper display panel, a control method thereof, and a display device. An electrophoretic reflective layer is disposed on an array substrate and located on a side of the array substrate facing a filter substrate. A controllable light reflective layer, a color filter layer, and a common electrode layer are sequentially disposed on a side of the filter substrate facing the array substrate. The color filter layer includes color resists spaced apart from each other, and an area between two adjacent color resists is a color resist gap. An orthographic projection of the controllable light reflective layer is located on the color resist gap. The common electrode layer controls light incident on the controllable light reflective layer to be reflected toward a side of the color filter layer away from the filter substrate or toward a side of the filter substrate away from the color filter layer.

### CROSS REFERENCE TO RELATED APPLICATIONS

The present disclosure claims the priority and benefit of Chinese Patent Application No. 2025103402029, titled "ELECTRONIC PAPER DISPLAY PANEL, CONTROL METHOD THEREOF, AND DISPLAY DEVICE" and filed on Mar. 21, 2025 with China National Intellectual Property Administration, the entire contents of which are incorporated herein by reference.

### TECHNICAL FIELD

The present disclosure relates to the technical field of display, and particularly to an electronic paper display panel, a control method thereof, and a display device.

### BACKGROUND

With the development of digital technology, an increasing number of display devices have entered people's lives, such as electronic paper (EP) display panels. Electronic paper display panels are being increasingly favored since electronic paper display panels may maintain display for extended periods without power and offer advantages including lightweight and thin profiles, low power consumption, and simple manufacturing processes. Adding a color filter substrate structure to existing electronic paper display panels has become an important approach to achieving color electronic paper display as the demand for color electronic paper display panels becomes urgent. However, the addition of the color filter substrate to current electronic paper display panels reduces the brightness of the display panels.

Therefore, light reflection structures or light guide structures are typically disposed between color resists. However, placing light reflection structures between the color resists causes bright line issues on the electronic paper display panel in brighter ambient light, while placing light guide structures between the color resists fails to adequately enhance the brightness of the panel in darker ambient light.

### SUMMARY

An objective of the present disclosure is to provide an electronic paper display panel, a control method thereof, and a display device. This solution enhances the brightness of the electronic paper display panel under weak ambient light conditions while preventing bright line display defects under strong ambient light conditions.

Disclosed in the present disclosure is an electronic paper display panel, including an array substrate, an electrophoretic reflective layer, a filter substrate, a controllable light reflective layer, a color filter layer, and a common electrode layer;

the array substrate and the filter substrate are disposed opposite to each other; the electrophoretic reflective layer is disposed on the array substrate and located on a side of the array substrate facing the filter substrate; the controllable light reflective layer, the color filter layer, and the common electrode layer are sequentially disposed on a side of the filter substrate facing the array substrate;

the color filter layer includes a plurality of color resists, each of the plurality of color resists being spaced apart from each other; an area between every two adjacent color resists is defined as a color resist gap; an orthographic projection of the controllable light reflective layer is located on the color resist gap; and the common electrode layer controls light incident on the controllable light reflective layer to be reflected toward a side of the color filter layer away from the filter substrate or toward a side of the filter substrate away from the color filter layer.

Optionally, a particle channel is disposed on the filter substrate; the controllable light reflective layer includes a plurality of white electrophoretic particles located within the particle channel; and the common electrode layer controls the plurality of white electrophoretic particles to move upward and downward.

Optionally, the particle channel includes a first inclined surface and a second inclined surface opposite to each other; an angle between the first inclined surface and a surface of the filter substrate close to the array substrate is greater than 90 degrees; and an angle between the second inclined surface and the surface of the filter substrate close to the array substrate is greater than 90 degrees.

Optionally, the plurality of color resists include a green color resist, a red color resist, and a blue color resist; the particle channel between the red color resist and the green color resist is defined as a first particle channel; the particle channel between the red color resist and the blue color resist is defined as a second particle channel; the particle channel between the green color resist and the blue color resist is defined as the second particle channel; a depth of the second particle channel is greater than that of the first particle channel.

Disclosed in the present disclosure is further a control method for an electronic paper display panel. The control method is configured to control the electronic paper display panel and includes the following steps:

detecting a light intensity incident on the electronic paper display panel;

controlling, by the common electrode layer, light incident on the controllable light reflective layer to be reflected toward a side of the color filter layer away from the filter substrate when the light intensity exceeds a preset intensity range; and

controlling, by the common electrode layer, light incident on the controllable light reflective layer to be reflected toward a side of the filter substrate away from the color filter layer when the light intensity falls below the preset intensity range.

Optionally, the controllable light reflective layer includes a plurality of white electrophoretic particles; the controlling, by the common electrode layer, light incident on the controllable light reflective layer to be reflected toward a side of the color filter layer away from the filter substrate when the light intensity exceeds the preset intensity range includes:

driving, by the common electrode layer, the plurality of white electrophoretic particles to move upward when the light intensity exceeds the preset intensity range, so as to control light incident on the controllable light reflective layer to be reflected toward the side of the color filter layer away from the filter substrate.

Optionally, the controlling, by the common electrode layer, light incident on the controllable light reflective layer to be reflected toward a side of the color filter layer away from the filter substrate when the light intensity exceeds the preset intensity range includes:

acquiring a display voltage at a pixel electrode when the light intensity exceeds the preset intensity range;

applying a first preset voltage to the common electrode layer and a second preset voltage to the pixel electrode, where a difference of the second preset voltage minus the display voltage is a preset negative value; maintaining an unchanged voltage difference between the pixel electrode and the common electrode layer within each pixel unit region; and driving the plurality of white electrophoretic particles to move upward.

Optionally, the controlling, by the common electrode layer, light incident on the controllable light reflective layer to be reflected toward a side of the filter substrate away from the color filter layer when the light intensity falls below the preset intensity range includes:

applying a third preset voltage to the common electrode layer to drive the plurality of white electrophoretic particles to move downward when the light intensity falls below the preset intensity range, so as to control light incident on the controllable light reflective layer to be reflected toward the side of the filter substrate away from the color filter layer; and

applying an original working voltage to the common electrode layer.

Optionally, the control method of the electronic paper display panel further includes:

acquiring information of a display image to determine an average gray level of the display image;

controlling, by the common electrode layer, light incident on the controllable light reflective layer to be reflected toward the side of the filter substrate away from the color filter layer when the average gray level exceeds a preset brightness range;

controlling, by the common electrode layer, light incident on the controllable light reflective layer to be reflected toward the side of the color filter layer away from the filter substrate when the average gray level falls below the preset brightness range.

Disclosed in the present disclosure is further a display device, including:
a detection module, configured to detect a light intensity incident on the electronic paper display panel;
a voltage control module, configured to acquire the light intensity detected by the detection module, determine whether the light intensity exceeds a preset intensity range, and control a voltage of the common electrode layer; and
the aforementioned electronic paper display panel,
where the detection module and the voltage control module are connected to the electronic paper display panel.

Compared with existing electronic paper display panels, the electronic paper display panel of the present disclosure disposes the controllable light reflective layer at positions corresponding to gaps between color resists. The common electrode layer controls light incident on the controllable light reflective layer to be reflected either toward a side of the color filter layer away from the filter substrate or toward a side of the filter substrate away from the color filter layer. Thus, the controllable light reflective layer may mimic the functionality of a white color resist to directly reflect light outward when ambient light intensity surrounding the electronic paper display panel is low, thereby enhancing the brightness of the electronic paper display panel. Light is guided into the electronic paper display panel when ambient light intensity surrounding the electronic paper display panel is high, so as to improve color performance without inducing bright line issues.

### BRIEF DESCRIPTION OF THE DRAWINGS

The included drawings are provided for further understanding of embodiments of the present disclosure, constitute a part of the specification, illustrate embodiments of the present disclosure, and together with the text description, explain principles of the present disclosure. Obviously, the drawings in the following description are merely some embodiments of the present disclosure. For those of ordinary skill in the art, other drawings may be obtained based on these drawings without creative labor. In the drawings:

FIG. 1 is a schematic diagram of an electronic paper display panel according to a first embodiment of the present disclosure;

FIG. 2 is a schematic diagram of an array substrate according to the first embodiment of the present disclosure;

FIG. 3 is a plan-view schematic diagram of a particle channel according to the first embodiment of the present disclosure;

FIG. 4 is a schematic diagram of a first particle channel and a second particle channel according to the first embodiment of the present disclosure;

FIG. 5 is a schematic diagram of a color resist according to the first embodiment of the present disclosure;

FIG. 6 is a schematic diagram of a display device according to an embodiment of the present disclosure;

FIG. 7 is a schematic diagram of a control method for an electronic paper display panel according to an embodiment of the present disclosure;

FIG. 8 is a schematic diagram of a common electrode layer according to an embodiment of the present disclosure;

FIG. 9 is a schematic diagram of an electronic paper display panel according to a second embodiment of the present disclosure;

FIG. 10 is a schematic diagram of an electronic paper display panel according to a third embodiment of the present disclosure.

Reference Numerals: 10, display device; 20, detection module; 30, voltage control module; 40, control circuit board; 50, common electrode driving chip; 100, electronic paper display panel; 200, array substrate; 210, array base; 220, active switch layer; 221, data line; 222, scan line; 223, active switch; 230, pixel electrode layer; 231, pixel electrode; 240, pixel unit region; 300, electrophoretic reflective layer; 400, filter substrate; 500, controllable light reflective layer; 510, particle channel; 511, first inclined surface; 512, second inclined surface; 521, first particle channel; 522, second particle channel; 530, base layer; 540, hemispherical groove; 550, partition wall; 560, white electrophoretic particle; 600, color filter layer; 610, color resist; 611, first color resist portion; 612, second color resist portion; 620, color resist gap; 630, light channel; 641, green color resist; 642, red color resist; 643, blue color resist; 700, common electrode layer; 710, common electrode.

### DETAILED DESCRIPTION

It should be understood that the terminology, specific structures, and functional details disclosed herein are merely used to describe specific embodiments and are illustrative. However, the present disclosure may be implemented through many alternative forms and should not be construed as limited solely to the embodiments described herein.

In the description of the present disclosure, terms such as "first" and "second" are used solely for descriptive purposes and should not be interpreted as indicating relative importance or implicitly specifying the number of technical features indicated. Thus, unless otherwise specified, features qualified by "first" or "second" may explicitly or implicitly include one or more such features. "A plurality of" means two or more. The term "comprises" and any variations thereof indicate non-exclusive inclusion, such that there may exist or be added one or more other features, integers, steps, operations, elements, components, and/or combinations thereof.

Additionally, directional or positional terms such as "center," "transversal," "upper," "lower," "left," "right," "vertical," "horizontal," "top," "bottom," "inside," or "outside" are described based on orientations or relative positional relationships shown in the accompanying drawings, which are used for simplified description to facilitate understanding of the present application and do not imply that the devices or elements described should have specific orientations or be constructed or operated in specific orientations. These terms should not be construed as limiting the present disclosure.

Additionally, unless otherwise explicitly specified and limited, the term "mount," "link," "connect," and the like should be understood in a broad sense, for example, as a fixed connection, as a detachable connection, as an integral connection, as a mechanical connection, as an electrical connection, as a direct connection, as an indirect connection through an intermediate medium, or as a connection within two elements. For those skilled in the art, the specific meaning of the above terms in the context of the present disclosure may be understood according to the specific situation.

The present disclosure is described below in detail with reference to the accompanying drawings and optional embodiments.

### Embodiment 1

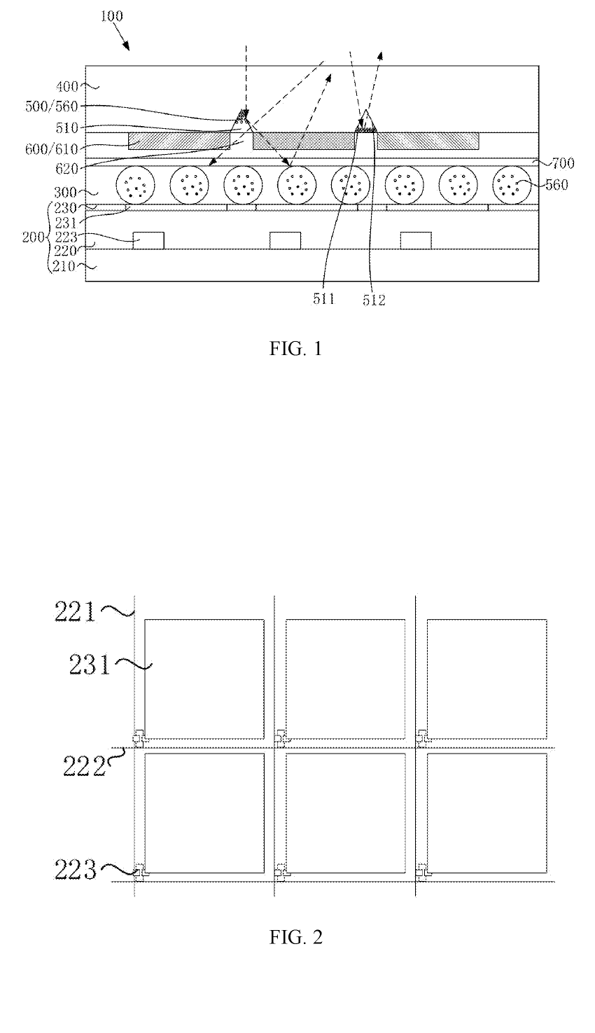

FIG. 1 is a schematic diagram of an electronic paper display panel according to a first embodiment of the present disclosure. As shown in FIG. 1, the direction indicated by the dashed arrows represents the propagation direction of some light rays. Disclosed in the present disclosure is an electronic paper display panel 100. The electronic paper display panel 100 includes an array substrate 200, an electrophoretic reflective layer 300, a filter substrate 400, a controllable light reflective layer 500, a color filter layer 600, and a common electrode layer 700.

The array substrate 200 and the filter substrate 400 are disposed opposite to each other. The electrophoretic reflective layer 300 is disposed on the array substrate 200 and located on a side of the array substrate 200 facing the filter substrate 400. The controllable light reflective layer 500, the color filter layer 600, and the common electrode layer 700 are sequentially disposed on a side of the filter substrate 400 facing the array substrate 200.

The color filter layer 600 includes a plurality of color resists 610. Each of the plurality of color resists 610 is spaced apart from each other. An area between every two adjacent color resists 610 is defined as a color resist gap 620. An orthographic projection of the controllable light reflective layer 500 is located on the color resist gap 620. The common electrode layer 700 controls light incident on the controllable light reflective layer 500 to be reflected toward a side of the color filter layer 600 away from the filter substrate 400 or toward a side of the filter substrate 400 away from the color filter layer 600.

FIG. 2 is a schematic diagram of an array substrate according to the first embodiment of the present disclosure. As shown in FIG. 2, the array substrate 200 includes an array base 210, an active switch layer 220, and a pixel electrode layer 230. The pixel electrode layer 230 includes a plurality of pixel electrodes 231. The active switch layer 220 includes data lines 221, scan lines 222, and active switches 223. The data lines 221 and scan lines 222 are arranged in a crisscross pattern to define a plurality of pixel unit regions 240. A gate of each active switch 223 is connected to a scan line 222, a source of each active switch 223 is connected to a data line 221, and a drain of each active switch 223 is connected to a pixel electrode 231. Each pixel unit region 240 is provided with an active switch 223 and a pixel electrode 231.

Exemplarily, in the present disclosure, the electrophoretic reflective layer 300 has a microcapsule structure including multiple microcapsules. Each microcapsule is filled with black electrophoretic particles and white electrophoretic particles 560. An electric field formed between the common electrode layer 700 and the pixel electrode 231 drives the movement of black electrophoretic particles and the plurality of white electrophoretic particles 560 within the microcapsules to reflect light for image display.

The present disclosure detects the light intensity incident on the electronic paper display panel 100. The common electrode layer 700 controls light incident on the controllable light reflective layer 500 to be reflected toward a side of the color filter layer 600 away from the filter substrate 400 when the light intensity exceeds a preset intensity range. This configuration further reduces color shift at the edges of the color resists 610 under strong ambient light conditions, enhances color saturation, improves the color performance of the electronic paper display panel 100, and prevents bright line phenomena at clearance of the color resist 610 caused by direct outward reflection from the controllable light reflective layer 500.

When the light intensity falls below the preset intensity range, the common electrode layer 700 controls light incident on the controllable light reflective layer 500 to be reflected toward a side of the filter substrate 400 away from the color filter layer 600. This effectively adds white color resists, thereby leading to an increase in the display brightness of the electronic paper display panel 100 when the ambient light intensity falls below the preset intensity range, so as to achieve brightness uniformity.

Compared with existing electronic paper display panels, the electronic paper display panel 100 of the present disclosure disposes the controllable light reflective layer 500 at positions corresponding to gaps between color resists 610. The common electrode layer 700 controls light incident on the controllable light reflective layer 500 to be reflected either toward a side of the color filter layer 600 away from the filter substrate 400 or toward a side of the filter substrate 400 away from the color filter layer 600. Thus, the controllable light reflective layer 500 may mimic the functionality of a white color resist to directly reflect light outward when ambient light intensity surrounding the electronic paper display panel 100 is low, thereby enhancing the brightness of the electronic paper display panel 100. Light is guided into the electronic paper display panel 100 when ambient light intensity surrounding the electronic paper display panel 100 is high, so as to improve color performance without inducing bright line issues.

Exemplarily, the width of the color resist gap 620 is equal to that of each color resist 610. The present embodiment exemplifies a configuration where the controllable light reflective layer 500 is directly disposed within the filter substrate 400. Specifically, a particle channel 510 is formed in the filter substrate 400. The controllable light reflective layer 500 includes a plurality of white electrophoretic particles 560 located within the particle channel 510. The common electrode layer 700 controls the plurality of white electrophoretic particles 560 to move upward and downward.

The plurality of white electrophoretic particles 560 are negatively charged. Thus, applying a positive voltage to the common electrode layer 700 drives the plurality of white electrophoretic particles 560 downward, while applying a negative voltage drives them upward. By forming the particle channel 510 in the filter substrate 400 and filling it with the plurality of white electrophoretic particles 560, the direction of reflection for light incident on the controllable light reflective layer 500 may be controlled by manipulating the movement of the particles. Additionally, integrating the particle channel 510 into the filter substrate 400 leads to a reduction in the thickness of the electronic paper display panel 100, thereby minimizing light attenuation.

The particle channel 510 includes a first inclined surface 511 and a second inclined surface 512 opposite to each other; an angle between the first inclined surface 511 and a surface of the filter substrate 400 close to the array substrate 200 is greater than 90 degrees; and an angle between the second inclined surface 512 and the surface of the filter substrate 400 close to the array substrate 200 is greater than 90 degrees. In essence, the cross-sectional shape of the particle channel 510 is triangular.

In some implementations, a range of the angle between the first inclined surface 511 and the substrate surface is from 115° to 135°, and a range of the angle between the second inclined surface 512 and the substrate surface is from 115° to 135°. This design ensures that most light rays incident on them are prevented from reflecting toward distant color resists 610 when the plurality of white electrophoretic particles 560 adhere to the inclined surfaces, thereby significantly enhancing the color performance of the electronic paper display panel 100.

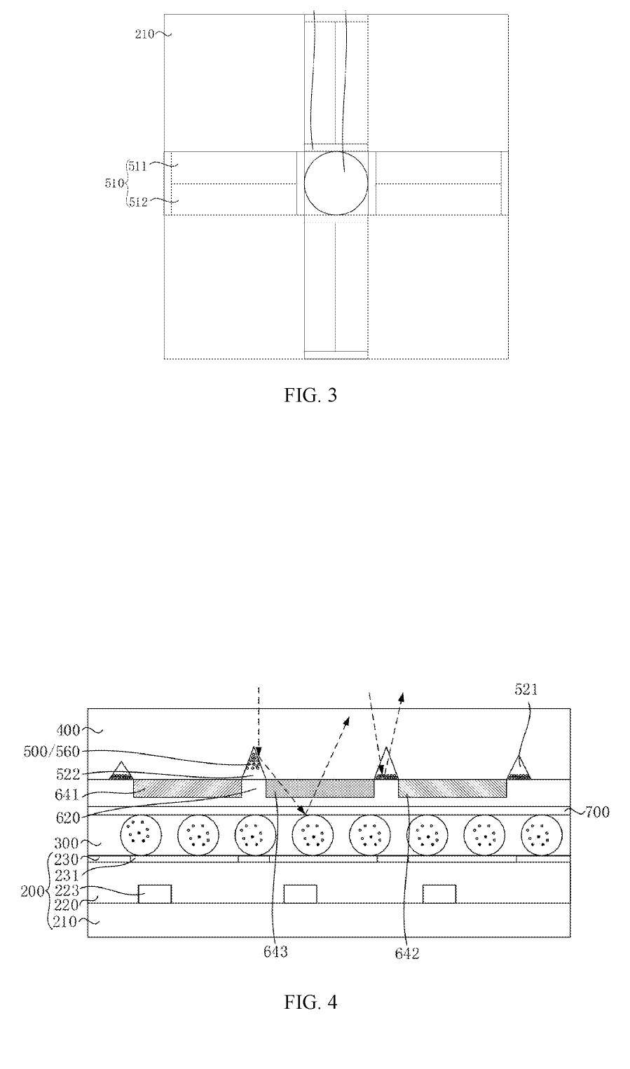

FIG. 3 is a plan-view schematic diagram of a particle channel according to the first embodiment of the present disclosure. As shown in FIG. 3, a hemispherical groove 540 and a partition wall 550 are further disposed on the filter substrate 400. The partition wall 550 separates the particle channel 510 and the hemispherical groove 540 from each other. An orthographic projection of the particle channel 510 is located between two adjacent color resists 610, namely at the color resist gap 620. An orthographic projection of the hemispherical groove 540 is located between four adjacent color resists 610 arranged in a grid pattern. The hemispherical groove 540 has a hemispherical shape, and the plurality of white electrophoretic particles 560 are also filled within the hemispherical groove 540.

The method for forming the hemispherical groove 540 and the particle channel 510 on the filter substrate 400 may involve first printing the shape of the hemispherical groove 540 and the particle channel 510 on one side of a master mold. Subsequently, liquid polyimide (PI) solution is poured onto the master mold. After cooling, the mold is demolded.

Thus, the common electrode layer 700 controls the plurality of white electrophoretic particles 560 to move upward when the ambient light intensity surrounding the electronic paper display panel 100 is high. Light rays are reflected toward the color resists 610 on either side of the particle channel 510 when light rays are incident on the first inclined surface 511 and the second inclined surface 512 of the particle channel 510. Simultaneously, light rays are reflected toward the color resists 610 surrounding the hemispherical groove 540 on all sides when light rays are incident on the inner wall of the hemispherical groove 540. This configuration prevents the occurrence of bright or dark spot issues at the intersection points of four color resists 610.

Continuing with reference to FIG. 1, according to the present disclosure, a ratio of the spatial volume within each individual particle channel 510 to the total volume of the plurality of white electrophoretic particles 560 within that particle channel 510 is 3:2. A ratio of the spatial volume within each individual hemispherical groove 540 to the total volume of the plurality of white electrophoretic particles 560 within that hemispherical groove 540 is 3:2. Under the influence of the common electrode layer 700, the plurality of white electrophoretic particles 560 aggregate at the top portions of the particle channel 510 and the hemispherical groove 540.

This configuration ensures that light rays perpendicularly incident on the first inclined surface 511 and the second inclined surface 512 are not entirely reflected directly outward. Light rays incident on the lower portions of the particle channel 510 and the hemispherical groove 540 may pass directly through the particle channel 510 and the hemispherical groove 540 into the interior plane, thereby reducing light loss, which further enhances the color performance of the electronic paper display panel 100 and prevents issues of bright lines being visible when viewed from wide viewing angles.

Defining the thickness of the filter substrate 400 as d1, the depth of the particle channel 510 and the hemispherical groove 540 as d2, the thickness of the electrophoretic reflective layer 300 as d3, and the width of the particle channel 510 as d4, the relationships are: 0 < d2 ≤ 1/2 d1, and 0 ≤ 1/2 d4 ≤ 1/2 d3. This design achieves controlled guidance of external light reflection while ensuring the structural integrity of the filter substrate 400.

As shown in FIG. 4, according to the present disclosure, the plurality of color resists 610 include a green color resist 641, a red color resist 642, and a blue color resist 643; the particle channel 510 between the red color resist 642 and the green color resist 641 is defined as a first particle channel 521; the particle channel 510 between the red color resist 642 and the blue color resist 643 is defined as a second particle channel 522; the particle channel 510 between the green color resist 641 and the blue color resist 643 is defined as the second particle channel 522; a depth of the second particle channel 522 is greater than that of the first particle channel 521.

Thus, the common electrode layer 700 controls the plurality of white electrophoretic particles 560 within the second particle channel 522 to move upward when the ambient light intensity is high, i.e., exceeds the preset intensity range. A majority of the light rays are reflected toward the blue color resist 643 when light rays are incident on the plurality of white electrophoretic particles 560 within the second particle channel 522 beside the blue color resist 643, thereby passing through the blue color resist 643 and irradiating the electrophoretic reflective layer 300 below. This increases the amount of light passing through the blue color resist 643, balances the characteristics caused by different light transmittance rates of various color resists, and avoids color shift issues in the electronic paper display panel 100.

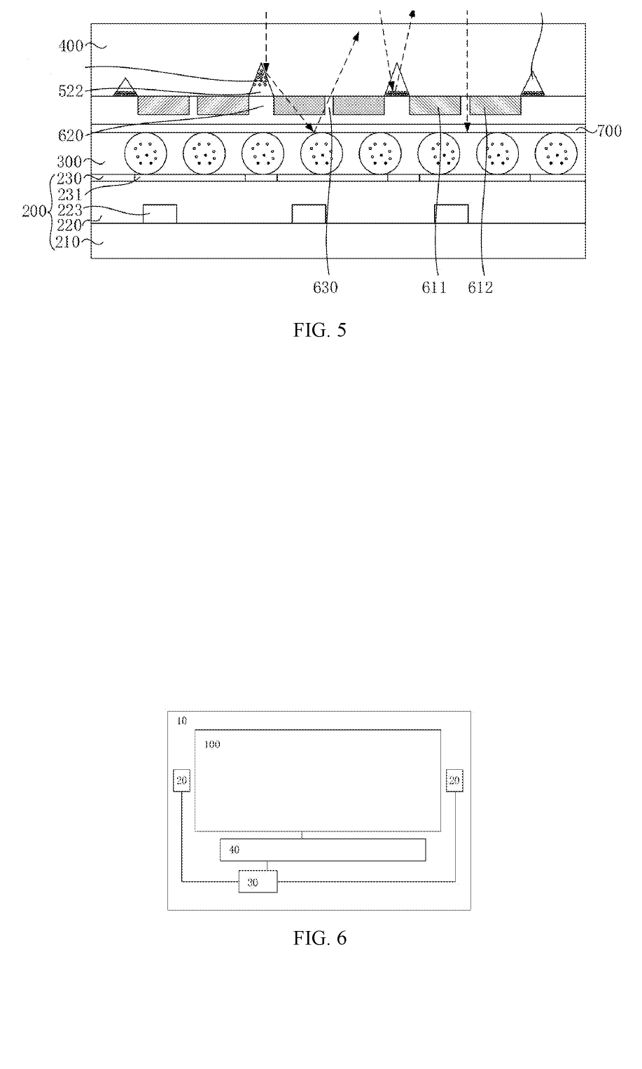

FIG. 5 is a schematic diagram of a color resist according to the first embodiment of the present disclosure. As shown in FIG. 5, to further enhance the display brightness of the electronic paper display panel 100, a light channel 630 is also disposed in the middle of each color resist 610. Specifically, the color resist 610 includes a first color resist portion 611, a second color resist portion 612, and a light channel 630. The light channel 630 is located between the first color resist portion 611 and the second color resist portion 612, and the light channel 630 divides the color resist 610 into two parts. This allows light rays to pass directly through the light channel 630 into the electronic paper display panel 100, leading to an increase in the amount of light entering the panel, thereby improving display brightness.

Exemplarily, the width of the color resist gap 620, the width of the first color resist portion 611, and the width of the second color resist portion 612 are equal to each other. The plurality of white electrophoretic particles 560 may act as a white color resist to enhance the display brightness of the electronic paper display panel 100 when the plurality of white electrophoretic particles 560 are located at the lower portion of the particle channel 510.

FIG. 6 is a schematic diagram of a display device according to an embodiment of the present disclosure. As shown in FIG. 6, disclosed in the present disclosure is further a display device 10. The display device 10 includes a detection module 20, a voltage control module 30, and the electronic paper display panel 100. The detection module 20 is configured to detect a light intensity incident on the electronic paper display panel 100. The voltage control module 30 is configured to acquire the light intensity detected by the detection module 20, determine whether the light intensity exceeds a preset intensity range, and control the voltage of the common electrode layer 700. The detection module 20 and the voltage control module 30 are connected to the electronic paper display panel 100.

The voltage control module 30 may also simultaneously control the voltage of the pixel electrodes 231. The light intensity information is transmitted to the voltage control module 30 after the detection module 20 detects the light intensity incident on the electronic paper display panel 100. The voltage control module 30 determines the relationship between the light intensity and the preset intensity range, thereby controlling only the voltage of the common electrode layer 700, or controlling the voltages of both the common electrode layer 700 and the pixel electrodes 231.

The detection module 20 may be disposed on the light exit surface side of the electronic paper display panel 100 and located in a non-display area. This configuration enables more precise detection of light intensity. Additionally, multiple detection modules 20 may be arranged in the non-display area. The light intensity data obtained by these detection modules 20 is summarized, inconsistent data is eliminated, and an average value is then calculated.

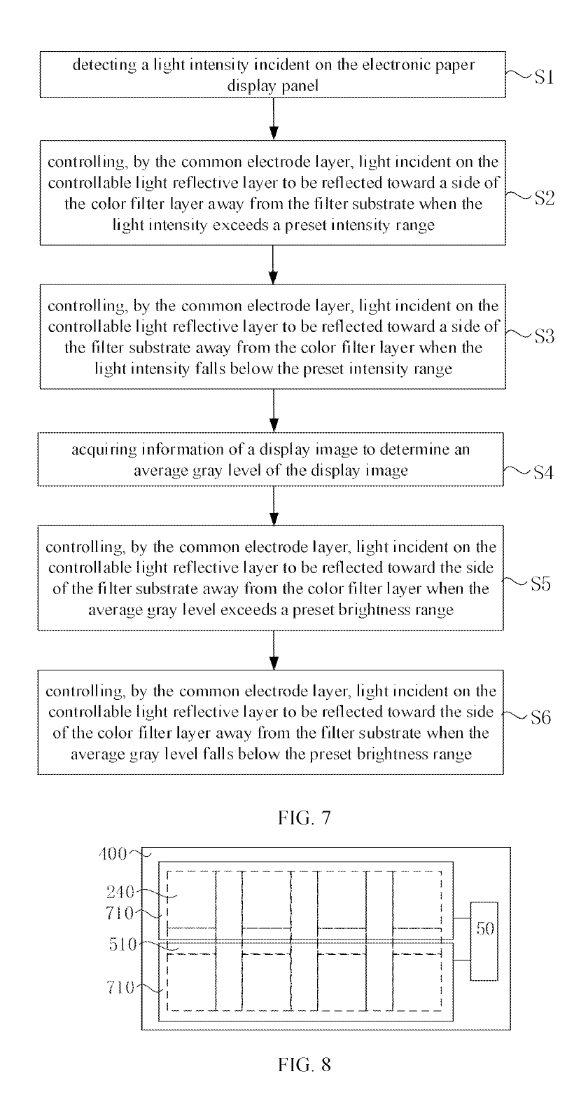

FIG. 7 is a schematic diagram of a control method for an electronic paper display panel according to an embodiment of the present disclosure. As shown in FIG. 7, disclosed in the present disclosure is further a control method for an electronic paper display panel, the control method for the electronic paper display panel is configured to control the electronic paper display panel 100, steps of the control method for the electronic paper display panel include:

S1: detecting a light intensity incident on the electronic paper display panel;

S2: controlling, by the common electrode layer, light incident on the controllable light reflective layer to be reflected toward a side of the color filter layer away from the filter substrate when the light intensity exceeds a preset intensity range; and

S3: controlling, by the common electrode layer, light incident on the controllable light reflective layer to be reflected toward a side of the filter substrate away from the color filter layer when the light intensity falls below the preset intensity range.

The intensity of light incident on the electronic paper display panel 100 may be detected by the detection module 20. Exemplarily, the detection module 20 includes a light sensor configured to detect light intensity.

The voltage control module 30 stores a preset intensity range value. By comparing the detected light intensity with the stored preset intensity range, a negative voltage is applied to the common electrode layer 700 when the detected light intensity exceeds the preset intensity range. This causes light incident on the controllable light reflective layer 500 to be reflected, pass through the color resists 610, and enter the interior of the electronic paper display panel 100. A positive voltage is applied to the common electrode layer 700 when the detected light intensity falls below the preset intensity range, causing light incident on the controllable light reflective layer 500 to be reflected directly outward.

Compared with existing electronic paper display panels, the electronic paper display panel 100 of the present disclosure disposes the controllable light reflective layer 500 at positions corresponding to gaps between color resists 610. The common electrode layer 700 controls light incident on the controllable light reflective layer 500 to be reflected either toward a side of the color filter layer 600 away from the filter substrate 400 or toward a side of the filter substrate 400 away from the color filter layer 600. Thus, the controllable light reflective layer 500 may mimic the functionality of a white color resist to directly reflect light outward when ambient light intensity surrounding the electronic paper display panel 100 is low, thereby enhancing the brightness of the electronic paper display panel 100. Light is guided into the electronic paper display panel 100 when ambient light intensity surrounding the electronic paper display panel 100 is high, so as to improve color performance without inducing bright line issues.

Furthermore, the present disclosure eliminates the need for additional dedicated electrodes to independently control the controllable light reflective layer 500. Instead, the pre-existing common electrode layer 700 within the electronic paper display panel 100 is employed to control the controllable light reflective layer 500 for light guidance, resulting in a structurally simpler electronic paper display panel 100.

Furthermore, the voltage control module 30 may acquire information about the display image of the electronic paper display panel 100. Specifically, the display device 10 further includes a control circuit board 40. The voltage control module 30 directly connects to the source driver chip within the control circuit board 40 to obtain display image information, thereby deriving the average gray level of the image.

For example, the data voltage is directly acquired from the source driver chip and the average gray level of the display image is evaluated through the average value of the data voltage.

S4: acquiring information of a display image to determine an average gray level of the display image;

S5: controlling, by the common electrode layer, light incident on the controllable light reflective layer to be reflected toward the side of the filter substrate away from the color filter layer when the average gray level exceeds a preset brightness range;

S6: controlling, by the common electrode layer, light incident on the controllable light reflective layer to be reflected toward the side of the color filter layer away from the filter substrate when the average gray level falls below the preset brightness range.

A preset brightness range is also pre-stored in the voltage control module 30. When the voltage control module 30 acquires the average gray level of the display image on the electronic paper display panel 100, the common electrode layer 700 controls light incident on the controllable light reflective layer 500 to be reflected toward a side of the filter substrate 400 away from the color filter layer 600 if the average gray level exceeds the preset brightness range. Conversely, the common electrode layer 700 controls light incident on the controllable light reflective layer 500 to be reflected toward a side of the color filter layer 600 facing away from the filter substrate 400 if the average gray level falls below the preset brightness range.

Compared with existing electronic paper display panels, the electronic paper display panel 100 of the present disclosure disposes the controllable light reflective layer 500 at positions corresponding to gaps between color resists 610. The common electrode layer 700 controls light incident on the controllable light reflective layer 500 to be reflected either toward a side of the color filter layer 600 away from the filter substrate 400 or toward a side of the filter substrate 400 away from the color filter layer 600. Thus, the controllable light reflective layer 500 may mimic the functionality of a white color resist to directly reflect light outward when the average gray level of the display image of the electronic paper display panel 100 exceeds the preset brightness range, thereby enhancing the brightness of the electronic paper display panel 100. Light is guided into the electronic paper display panel 100 when the average gray level of the display image of the electronic paper display panel 100 falls below the preset brightness range, so as to improve color performance without inducing bright line issues.

Specifically, according to the present disclosure, the reflection angle of light is controlled by manipulating the position of the plurality of white electrophoretic particles 560, and the controllable light reflective layer 500 includes the plurality of white electrophoretic particles 500; step of S2: controlling, by the common electrode layer, light incident on the controllable light reflective layer to be reflected toward a side of the color filter layer away from the filter substrate when the light intensity exceeds a preset intensity range, includes:

S21: driving, by the common electrode layer, the plurality of white electrophoretic particles to move upward when the light intensity exceeds the preset intensity range, so as to control light incident on the controllable light reflective layer to be reflected toward the side of the color filter layer away from the filter substrate.

The common electrode layer 700 may either solely alter its own voltage or simultaneously adjust the voltage of both the common electrode layer 700 and the pixel electrode layer 230 when the common electrode layer 700 drives the plurality of white electrophoretic particles 560 to move upward.

In some implementations, according to the present disclosure, the voltage of both the common electrode layer 700 and the pixel electrode layer 230 is changed simultaneously. This approach controls the movement of the plurality of white electrophoretic particles 560 within the controllable light reflective layer 500 while preventing interference with the underlying electrophoretic reflective layer 300, thereby avoiding display abnormalities. Specifically:

step of S21: the controlling, by the common electrode layer, light incident on the controllable light reflective layer to be reflected toward a side of the color filter layer away from the filter substrate when the light intensity exceeds the preset intensity range, includes:

S211: acquiring a display voltage at a pixel electrode when the light intensity exceeds the preset intensity range;

S212: applying a first preset voltage to the common electrode layer and a second preset voltage to the pixel electrode, where a difference of the second preset voltage minus the display voltage is a preset negative value; maintaining an unchanged voltage difference between the pixel electrode and the common electrode layer within each pixel unit region; and driving the plurality of white electrophoretic particles to move upward.

The voltage control module 30 may directly acquire the display voltage of the pixel electrode 231 for each pixel unit region 240 in the current image from the source driver chip within the control circuit board 40. The display voltage represents the working voltage of the pixel electrode 231 under the present display panel conditions.

Exemplarily, the original working voltage of the common electrode 710 is +1V. To control the upward movement of the plurality of white electrophoretic particles 560, a first preset voltage is applied as a negative voltage of -3V to the common electrode layer 700. The preset difference (between the second preset voltage and the display voltage) is -4V. Thus, the voltage control module 30 reapplies a second preset voltage of +11V to that pixel electrode 231 when the display voltage of a pixel electrode 231 is +15V. The voltage control module 30 reapplies a second preset voltage of -19V to that pixel electrode 231 when the display voltage of a pixel electrode 231 is -15V. This maintains an unchanged voltage difference between the pixel electrode 231 and the common electrode layer 700 within each pixel unit region while simultaneously achieving upward movement of the plurality of white electrophoretic particles 560.

Since the alteration of the pixel electrode 231 voltage is performed row by row, according to the present disclosure, the structure of the common electrode layer 700 is further improved. FIG. 8 is a schematic diagram of a common electrode layer according to an embodiment of the present disclosure. As shown in FIG. 8, the common electrode layer 700 includes multiple independent common electrodes 710. The length direction of each common electrode 710 aligns with the length direction of a scan line 222. The orthographic projection of each common electrode 710 covers one row of pixel electrodes 231 connected to a single scan line 222, as well as portions of the particle channels 510 and hemispherical grooves 540 located between two vertically adjacent rows of pixel electrodes 231.

In step of S212: applying a first preset voltage to the common electrode layer and a second preset voltage to the pixel electrode, where a difference of the second preset voltage minus the display voltage is a preset negative value; maintaining an unchanged voltage difference between the pixel electrode and the common electrode layer within each pixel unit region; and driving the plurality of white electrophoretic particles to move upward.

While applying a second preset voltage (with a preset difference from the display voltage) to the pixel electrodes 231 of the same row, a first preset voltage is applied only to the single common electrode 710 whose orthographic projection overlaps with that same row of pixel electrodes 231, ensuring that the voltages of the common electrode 710 above and the pixel electrodes 231 below the electrophoretic reflective layer 300 within the electronic paper display panel 100 change simultaneously, avoiding altering the voltage across the entire common electrode layer 700 at once, thereby preventing display abnormalities.

Exemplarily, the display device 10 further includes a common electrode driving chip 50 connected to the common electrodes 710. The common electrode driving chip 50 controls the voltage input to the common electrodes 710. While applying the second preset voltage (with the preset difference from the display voltage) to the pixel electrodes 231 of the same row, the first preset voltage is only applied to the single common electrode 710 whose orthographic projection overlaps with that same row of pixel electrodes 231. The common electrode driving chip 50 may be directly disposed on the filter substrate 400. Furthermore, the common electrode driving chip 50 is further connected to the Tcon (Timing Controller) chip within the control circuit board 40. It monitors signals sent from the Tcon chip to the source driver chip, enabling the synchronization where, while the second preset voltage (with the preset difference) is applied to a row of pixel electrodes 231, the first preset voltage is applied only to the overlapping common electrode 710 for that same row of pixel electrodes 231.

step of S3: the controlling, by the common electrode layer, light incident on the controllable light reflective layer to be reflected toward a side of the filter substrate away from the color filter layer when the light intensity falls below the preset intensity range, includes:

S311: applying a third preset voltage to the common electrode layer to drive the plurality of white electrophoretic particles to move downward when the light intensity falls below the preset intensity range, so as to control light incident on the controllable light reflective layer to be reflected toward the side of the filter substrate away from the color filter layer; and

S312: applying an original working voltage to the common electrode layer.

Downward movement of the plurality of white electrophoretic particles 560 originally within the particle channels 510 and hemispherical grooves 540 needs to be driven when the light intensity falls below the preset intensity range. This requires applying a positive voltage to the common electrode layer 700. The third preset voltage may be greater than or equal to the original working voltage.

Only the voltage of the common electrode layer 700 may be altered when applying the third preset voltage to the common electrode layer 700. The original working voltage is reapplied to the common electrode layer 700 after completing the downward movement of the plurality of white electrophoretic particles 560, which avoids altering the voltage of the pixel electrodes 231, making control simpler.

Alternatively, a fourth preset voltage may be simultaneously applied to the pixel electrodes 231 while applying the third preset voltage to the common electrode layer 700. Specifically:

S321: acquiring a display voltage at a pixel electrode when the light intensity falls below the preset intensity range;

S322: applying a third preset voltage to the common electrode layer and a fourth preset voltage to the pixel electrode, where a difference of the fourth preset voltage minus the display voltage is a preset positive value; maintaining an unchanged voltage difference between the pixel electrode and the common electrode layer within each pixel unit region; and driving the plurality of white electrophoretic particles to move downward.

The voltage control module 30 may directly acquire the display voltage of the pixel electrode 231 for each pixel unit region 240 in the current image from the source driver chip within the control circuit board 40.

Exemplarily, the original working voltage of the common electrode 710 is +1V. To control the downward movement of the plurality of white electrophoretic particles 560, a third preset voltage is applied as a positive voltage of +6V to the common electrode layer 700. The preset difference (between the second preset voltage and the display voltage) is +5V. Thus, the voltage control module 30 reapplies a fourth preset voltage of +20V to that pixel electrode 231 when the display voltage of a pixel electrode 231 is +15V. The fourth preset voltage is -10V when the display voltage of a pixel electrode 231 is -15V. This maintains an unchanged voltage difference between the pixel electrode 231 and the common electrode layer 700 within each pixel unit region while simultaneously achieving downward movement of the plurality of white electrophoretic particles 560.

### Embodiment 2

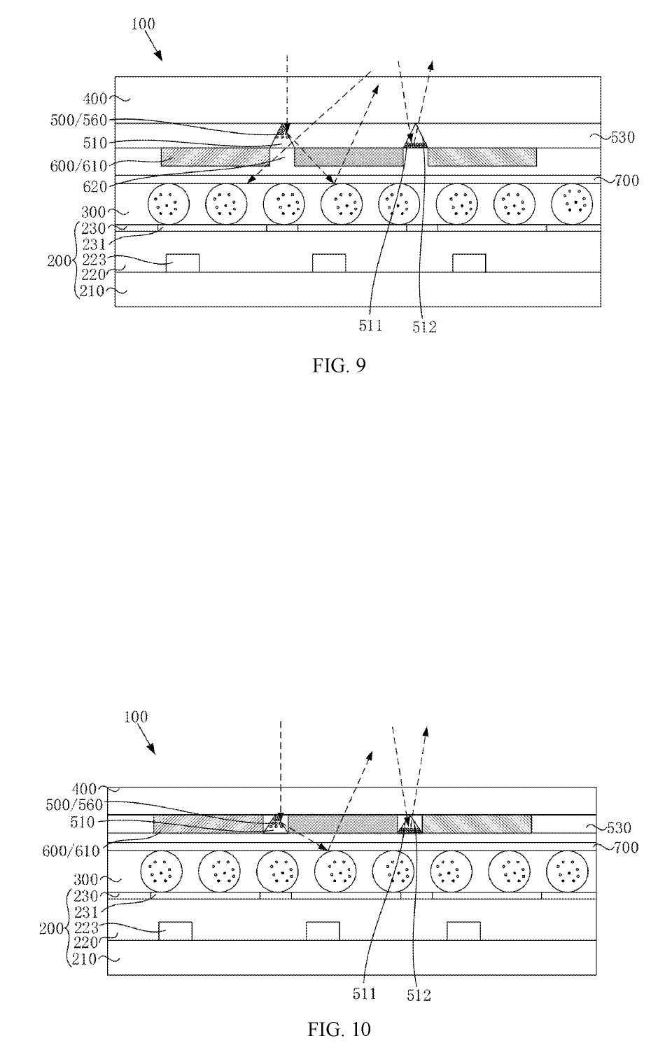

FIG. 9 is a schematic diagram of an electronic paper display panel according to a second embodiment of the present disclosure. As shown in FIG. 9, differing from Embodiment 1, the controllable light reflective layer 500 in the present embodiment is disposed between the filter substrate 400 and the color filter layer 600. Specifically, the controllable light reflective layer 500 includes a base layer 530 and a plurality of white electrophoretic particles 560. The base layer 530 is disposed between the filter substrate 400 and the color filter layer 600. Particle channels 510 are formed in the base layer 530, and the plurality of white electrophoretic particles 560 are located within these particle channels 510. The common electrode layer 700 controls the upward and downward movement of the plurality of white electrophoretic particles 560. The base layer 530 further includes hemispherical grooves 540 and partition walls 550. The partition walls 550 separate the particle channels 510 from the hemispherical grooves 540. An orthographic projection of each particle channel 510 is located between two adjacent color resists 610, namely at the color resist gap 620. An orthographic projection of each hemispherical groove 540 is located between four adjacent color resists 610 arranged in a grid pattern. The hemispherical grooves 540 have a hemispherical shape and are filled with the plurality of white electrophoretic particles 560.

The base layer 530 in the present embodiment is fabricated from an insulating material or passivation layer material. Compared to the solution of Embodiment 1, forming the particle channels 510 and hemispherical grooves 540 on the base layer 530 offers a simpler process. Furthermore, it avoids the need for thickening the array substrate 210 and does not compromise the protective function of the array substrate 210 for the electronic paper display panel 100.

### Embodiment 3

FIG. 10 is a schematic diagram of an electronic paper display panel according to a third embodiment of the present disclosure. As shown in FIG. 10, differing from Embodiment 1, the controllable light reflective layer 500 in the present embodiment is disposed between the color resists 610. Specifically, the controllable light reflective layer 500 includes a base layer 530 and a plurality of white electrophoretic particles 560. The base layer 530 is positioned between the color resists 610. Particle channels 510 are formed in the base layer 530, and the plurality of white electrophoretic particles 560 are located within these particle channels 510. The common electrode layer 700 controls the upward and downward movement of the plurality of white electrophoretic particles 560. The base layer 530 further includes hemispherical grooves 540 and partition walls 550. The partition walls 550 separate the particle channels 510 from the hemispherical grooves 540. The particle channels 510 are located between two adjacent color resists 610, namely at the color resist gap 620. The hemispherical grooves 540 are located between four adjacent color resists 610 arranged in a grid pattern. The hemispherical grooves 540 have a hemispherical shape and are filled with the plurality of white electrophoretic particles 560.

The base layer 530 in the present embodiment is fabricated from an insulating material or passivation layer material. Compared to the solution of Embodiment 1, according to the present embodiment, the thickness of the electronic paper display panel 100 is reduced by placing the controllable light reflective layer 500 directly between the color resists 610. Furthermore, light rays reflected from the controllable light reflective layer 500 toward the color resists 610 do not need to pass through a relatively thick color resist layer, thereby minimizing light loss and enhancing the brightness of the electronic paper display panel 100.

Moreover, and more importantly, this configuration eliminates the need to reduce the number of the plurality of white electrophoretic particles to avoid bright line issues visible at wide viewing angles.

It should be noted that the limitations regarding each step involved in the present solution do not constitute restrictions on the sequence of steps, provided such limitations do not affect the implementation of the specific solution. Steps described earlier may be executed first, executed later, or even executed simultaneously. As long as the present solution is able to be implemented, all such variations should be regarded as falling within the protection scope of the present disclosure.

It should be noted that the inventive concept of the present disclosure may be formed into many embodiments, but limitations of the application document preclude exhaustive listing. Therefore, should no conflict be present, the various embodiments or technical features described above may be arbitrarily combined to form new embodiments. After the various embodiments or technical features are combined, the original technical effects may be enhanced.

The foregoing content describes the present disclosure in further detail in conjunction with specific optional embodiments, but it should not be construed that the specific implementation of the present disclosure is limited solely to these descriptions. For those of ordinary skill in the art to which the present disclosure pertains, several simple deductions or replacements may be made without departing from the inventive concept of the present disclosure, and these should all be regarded as falling within the protection scope of the present disclosure.

What is claimed is:

1. An electronic paper display panel, wherein the electronic paper display panel comprises an array substrate, an electrophoretic reflective layer, a filter substrate, a controllable light reflective layer, a color filter layer, and a common electrode layer;
the array substrate and the filter substrate are disposed opposite to each other; the electrophoretic reflective layer is disposed on the array substrate and located on a side of the array substrate facing the filter substrate; the controllable light reflective layer, the color filter layer, and the common electrode layer are sequentially disposed on a side of the filter substrate facing the array substrate;
the color filter layer comprises a plurality of color resists, each of the plurality of color resists being spaced apart from each other; an area between every two adjacent color resists is defined as a color resist gap; an orthographic projection of the controllable light reflective layer is located on the color resist gap; and the common electrode layer controls light incident on the controllable light reflective layer to be reflected toward a side of the color filter layer away from the filter substrate or toward a side of the filter substrate away from the color filter layer.

2. The electronic paper display panel according to claim 1, wherein a particle channel is disposed on the filter substrate; the controllable light reflective layer comprises a plurality of white electrophoretic particles located within the particle channel; and the common electrode layer controls the plurality of white electrophoretic particles to move upward and downward.

3. The electronic paper display panel according to claim 2, wherein the particle channel comprises a first inclined surface and a second inclined surface opposite to each other; an angle between the first inclined surface and a surface of the filter substrate close to the array substrate is greater than 90 degrees; and an angle between the second inclined surface and the surface of the filter substrate close to the array substrate is greater than 90 degrees.

4. The electronic paper display panel according to claim 3, wherein the plurality of color resists comprise a green color resist, a red color resist, and a blue color resist; the particle channel between the red color resist and the green color resist is defined as a first particle channel; the particle channel between the red color resist and the blue color resist is defined as a second particle channel; the particle channel between the green color resist and the blue color resist is defined as the second particle channel; a depth of the second particle channel is greater than that of the first particle channel.

5. The electronic paper display panel according to claim 1, wherein a width of the color resist gap is equal to that of each of the plurality of color resists.

6. The electronic paper display panel according to claim 3, wherein a range of an angle between the first inclined surface and a surface of the filter substrate close to the array substrate is from 115° to 135°; and a range of an angle between the second inclined surface and the surface of the filter substrate close to the array substrate is from 115° to 135°.

7. The electronic paper display panel according to claim 2, wherein a hemispherical groove and a partition wall are further disposed on the filter substrate; the partition wall separates the particle channel and the hemispherical groove from each other; an orthographic projection of the particle channel is located between two adjacent color resists; an orthographic projection of the hemispherical groove is located between four adjacent color resists arranged in a grid pattern; a shape of the hemispherical groove is hemispherical; and the plurality of white electrophoretic particles are filled in the hemispherical groove.

8. The electronic paper display panel according to claim 7, wherein a ratio of a spatial volume within each individual particle channel to a total volume of the plurality of white electrophoretic particles within the particle channel is 3:2; a ratio of a spatial volume within each individual hemispherical groove to a total volume of the plurality of white electrophoretic particles within the hemispherical groove is 3:2.

9. The electronic paper display panel according to claim 7, wherein a thickness of the filter substrate is defined as d1; a depth of the particle channel and the hemispherical groove is defined as d2; a thickness of the electrophoretic reflective layer is defined as d3; a width of the particle channel is defined as d4; 0 < d2 ≤ 1/2 d1; and 0 ≤ 1/2 d4 ≤ 1/2 d3.

10. The electronic paper display panel according to claim 2, wherein each of the plurality of color resists comprises a first color resist portion, a second color resist portion, and a light channel; the light channel is located between the first color resist portion and the second color resist portion; and the light channel separates each of the plurality of color resists into two portions.

11. The electronic paper display panel according to claim 10, wherein a width of the color resist gap, a width of the first color resist portion, and a width of the second color resist portion are equal to each other.

12. A control method for an electronic paper display panel, wherein the control method is applied to control the electronic paper display panel;
wherein the electronic paper display panel comprises an array substrate, an electrophoretic reflective layer, a filter substrate, a controllable light reflective layer, a color filter layer, and a common electrode layer;
the array substrate and the filter substrate are disposed opposite to each other; the electrophoretic reflective layer is disposed on the array substrate and located on a side of the array substrate facing the filter substrate; the controllable light reflective layer, the color filter layer, and the common electrode layer are sequentially disposed on a side of the filter substrate facing the array substrate;
the color filter layer comprises a plurality of color resists, each of the plurality of color resists being spaced apart from each other; an area between every two adjacent color resists is defined as a color resist gap; an orthographic projection of the controllable light reflective layer is located on the color resist gap; and the common electrode layer controls light incident on the controllable light reflective layer to be reflected toward a side of the color filter layer away from the filter substrate or toward a side of the filter substrate away from the color filter layer;
wherein the control method for the electronic paper display panel comprises:
detecting a light intensity incident on the electronic paper display panel;
controlling, by the common electrode layer, light incident on the controllable light reflective layer to be reflected toward a side of the color filter layer away from the filter substrate when the light intensity exceeds a preset intensity range; and
controlling, by the common electrode layer, light incident on the controllable light reflective layer to be reflected toward a side of the filter substrate away from the color filter layer when the light intensity falls below the preset intensity range.

13. The control method for the electronic paper display panel according to claim 12, wherein the controllable light reflective layer comprises a plurality of white electrophoretic particles; the controlling, by the common electrode layer, light incident on the controllable light reflective layer to be reflected toward a side of the color filter layer away from the filter substrate when the light intensity exceeds the preset intensity range comprises:
driving, by the common electrode layer, the plurality of white electrophoretic particles to move upward when the light intensity exceeds the preset intensity range, so as to control light incident on the controllable light reflective layer to be reflected toward the side of the color filter layer away from the filter substrate.

14. The control method for the electronic paper display panel according to claim 13, wherein the controlling, by the common electrode layer, light incident on the controllable light reflective layer to be reflected toward a side of the color filter layer away from the filter substrate when the light intensity exceeds the preset intensity range comprises:
acquiring a display voltage at a pixel electrode when the light intensity exceeds the preset intensity range;
applying a first preset voltage to the common electrode layer and a second preset voltage to the pixel electrode, wherein a difference of the second preset voltage minus the display voltage is a preset negative value; maintaining an unchanged voltage difference between the pixel electrode and the common electrode layer within each pixel unit region; and driving the plurality of white electrophoretic particles to move upward.

15. The control method for the electronic paper display panel according to claim 13, wherein the controlling, by the common electrode layer, light incident on the controllable light reflective layer to be reflected toward a side of the filter substrate away from the color filter layer when the light intensity falls below the preset intensity range comprises:
applying a third preset voltage to the common electrode layer to drive the plurality of white electrophoretic particles to move downward when the light intensity falls below the preset intensity range, so as to control light incident on the controllable light reflective layer to be reflected toward the side of the filter substrate away from the color filter layer; and
applying an original working voltage to the common electrode layer.

16. The control method for the electronic paper display panel according to claim 12, further comprising:
acquiring information of a display image to determine an average gray level of the display image;
controlling, by the common electrode layer, light incident on the controllable light reflective layer to be reflected toward the side of the filter substrate away from the color filter layer when the average gray level exceeds a preset brightness range; and
controlling, by the common electrode layer, light incident on the controllable light reflective layer to be reflected toward the side of the color filter layer away from the filter substrate when the average gray level falls below the preset brightness range.

17. A display device, comprising:
a detection module, configured to detect a light intensity incident on the electronic paper display panel;
a voltage control module, configured to acquire the light intensity detected by the detection module, determine whether the light intensity exceeds a preset intensity range, and control a voltage of the common electrode layer; and
an electronic paper display panel, wherein the electronic paper display panel comprises an array substrate, an electrophoretic reflective layer, a filter substrate, a controllable light reflective layer, a color filter layer, and a common electrode layer;
the array substrate and the filter substrate are disposed opposite to each other; the electrophoretic reflective layer is disposed on the array substrate and located on a side of the array substrate facing the filter substrate; the controllable light reflective layer, the color filter layer, and the common electrode layer are sequentially disposed on a side of the filter substrate facing the array substrate;
the color filter layer comprises a plurality of color resists, each of the plurality of color resists being spaced apart from each other; an area between every two adjacent color resists is defined as a color resist gap; an orthographic projection of the controllable light reflective layer is located on the color resist gap; and the common electrode layer controls light incident on the controllable light reflective layer to be reflected toward a side of the color filter layer away from the filter substrate or toward a side of the filter substrate away from the color filter layer; and
wherein the detection module and the voltage control module are connected to the electronic paper display panel.

18. The display device according to claim 17, wherein the detection module is disposed on a side of a light exit surface of the electronic paper display panel.
